(19) United States
(12) Patent Application Publication
(10) Pub. No.: US 2004/0216359 A1
(43) Pub. Date: Nov. 4, 2004

(54) Pivoting jig head and hook combination

(76) Inventor: Allan David Mitchell, Sydney (AU)

Correspondence Address: STEPHEN CHRISTOPHER SWIFT, SWIFT LAW OFFICE, SUITE 200, 1940 DUKE STREET, ALEXANDRIA, VA, 22314-3451, US

(21) Appl. No.: 10/856,944

(22) Filed: Jun. 1, 2004

Related U.S. Application Data
(63) Continuation-in-part of application No. 10/375,035, filed on Feb. 28, 2003.
(60) Provisional application No. 60/361,199, filed on Feb. 28, 2002.

(51) Int. Cl. A01K 85/00

(52) U.S. Cl. 43/42.36

(57) ABSTRACT

A pivoting jig head and hook combination for fishing. The combination functions as a action producing lure wherein the intimacy between the tail portion of the plastic lure body and the rear portion of hook stabilizes the position of the jig head on the shank along with forward motion of the combination as it is pulled through water. The pivoting of the jig head provides additional action to the tail portion of the plastic lure body. The jig head maybe dynamically formed to produce a variety of side to side actions when pulled forward through the water. Attractant material that fish can smell in the water may be placed in cavities in the jig head and/or lure body. As the combination has two components, the rattling or vibrations created during the combination's forward motion may develop a desirable sonic attraction.

### CROSS REFERENCE TO RELATED APPLICATION

This application is a Continuation-In-Part of Regular patent application Ser. No. 10/375,035, filed on Feb. 28, 2003, which was based on Provisional Patent Application Ser. No. 60/361,199, filed on Feb. 28, 2002.

### BACKGROUND OF THE INVENTION

1. Field of the Invention

The present invention relates to apparatus used to attract and catch fish.

2. Description of the Prior Art

In the art of fishing there are devices that are known as jigs, which are usually weighted with lead or steel. Commonly, a hook portion of the jig supports a soft plastic tube bait, live bait, a skirt or other attractant to fish. A problem with the prior art is that the jig head is fixed in an immovable fashion to the hook. This severely limits the swimming or undulating motion available to the attractor portion of the combination.

U.S. Pat. No. 456,931, issued on Aug. 4, 1891, to Albert Angel, discloses a revolving wing attachment for fish hooks. The instant invention is distinguishable in that it does not include revolving wings.

U.S. Pat. No. 570,632, issued on Nov. 3, 1896, to James T. Hastings, discloses a fish hook to which is attached a piece of sheet metal that spins about the hook. The instant invention is distinguishable in that it does not include a piece of sheet metal spinning about a hook.

U.S. Pat. No. 1,116,025, issued on Nov. 3, 1914, to Charles E. Cripe, discloses a cone-shaped artificial lure with propeller shaped blades that spins about a fish hook. The instant invention is distinguishable in that it involves pivoting rather than spinning.

U.S. Pat. No. 1,313,567, issued on Aug. 19, 1919, to Charles B. Ulrich, discloses a trolling attachment for fishing lines, with a spinner that spins about an axis in the direction in which it is pulled. Again, the instant invention is distinguishable in that it involves pivoting rather than spinning.

U.S. Pat. No. 1,573,288, issued on Feb. 16, 1926, to Albert W. Wilson, discloses a trolling gear with spinner having a channel or “opening” 14 that is open along one side of its axis, rather than merely at its ends, as in the instant invention.

U.S. Pat. No. 1,830,080, issued on Nov. 3, 1931, to Harold G. Allen, discloses a fish lure that when drawn through the water flaps or oscillates its wings to simulate a struggling insect or small bird. The instant invention is distinguishable in that it does not have wings.

U.S. Pat. No. 1,871,971, issued on Aug. 16, 1932, to Frederick E. Eppich, discloses fish lure having a plate designed to spin about an axis in the direction it is pulled, rather than pivot back and forth like the jig head of the instant invention.

U.S. Pat. No. 2,112,901, issued on Apr. 5, 1938, to Charles N. Anderson, discloses a fish lure which darts back and forth on the fishing line, rather than pivoting about a hook as in the instant invention.

U.S. Pat. No. 2,294,971, issued on Sep. 8, 1942, to Charles E. Fehringer, discloses a fish lure, that neither pivots diagonally nor uses an attractant that fish can smell, as in the instant invention.

U.S. Pat. No. 2,792,663, issued on May 21, 1957, to Robert C. Sinclair, discloses a fishhook attached to a float that is attached to a line attached to a sinker that rests on the bottom of a body of water. Movement of the water causes the line, float and hook to undulate. The instant invention is distinguishable, in that it pivots as it is pulled through the water.

U.S. Pat. No. 3,010,243, issued on Nov. 28, 1961, to John T. Dickinson, discloses a convertible fishing lure, with a cylindrical bore that may extend diagonally through the lure, but it does not disclose the retention of the straight portion of a hook in the bore or channel, as in the instant invention.

U.S. Pat. No. 4,098,017, issued on Jul. 4, 1978, to Joe Patrick Hall, discloses fishing lure through which water flows and makes noise, but does not disclose the use of an attractant that fish can smell, as in the instant invention.

U.S. Pat. No. 4,803,798, issued on Feb. 14, 1989, to Dan L. Hannah, discloses a fishing sinker designed to align a fishhook so that the main barb of the hook is directed toward the upper or lower portion of a fish's mouth. It does not disclose the fishhook having a straight portion that extends through the sinker, nor the use of an attractant that fish can smell, as in the instant invention.

U.S. Pat. No. 4,843,754, issued on Jul. 4, 1989, to Harold F. Spelts, discloses a fishhook and lure, designed to prevent the lure from rotating, rather than allowing it to pivot, as in the instant invention.

U.S. Pat. No. 5,142,811, issued on Sep. 1, 1992, to Carl W. Freeman, discloses a fishing lure and lure enhancement kit, in which a shank portion of a hook is disposed within the bore, but does not disclose a straight portion of the hook passing diagonally through the lure, as in the instant invention.

U.S. Pat. No. 6,035,574, issued on Mar. 14, 2000, to Brett Ware, discloses a fishing lure with a shaft passing through its body designed to cause water passing through the shaft to generate vibrations of a pre-determined frequency known to attract fish. A hook is securely fastened to the body, but does not pivot within the body, nor does the lure pivot about the hook, as in the instant invention.

U.S. Pat. No. 6,505,432, issued on Jan. 14, 2003, to Stephen M. Brinkman, discloses a fish catching system, including a decapod-shaped lure that pivots when it is manipulated by the user, rather than pivoting spontaneously when it is pulled through the water, as in the instant invention.

U.S. Pat. No. 6,519,895, issued on Feb. 18, 2003, to Thomas Joseph Bennett, discloses a fish hook for use with bait, with an elongated shank have first and second ends for attachment to the bait, rather than a straight portion that passes through a lure, as in the instant invention.

U.S. Pat. No. Des. 331,788, issued on Dec. 15, 1992, to Leslie R. Jensen, discloses a design for a combined lure holder and weed guard, in which the lure is held by a clamp, rather than pivoting on a hook, as in the instant invention.

Japanese Pat. Application No. 5-227862, published on Sep. 7, 1993, to Horimoto Toshikazu, discloses a jig head with a fish-shaped sinker of lead attached to the shank of a hook, but the shank of the hook does not pass through a diagonal channel in the jig head, as in the instant invention.

None of the above inventions and patents, taken either singly or in combination, is seen to describe the instant invention as claimed.

### SUMMARY OF THE INVENTION

The present invention is a pivoting jig head and hook combination for fishing. The combination functions as a action producing lure wherein the intimacy between the tail portion of the plastic lure body and the rear portion of hook stabilizes the position of the jig head on the shank along with forward motion of the combination as it is pulled through water. The pivoting of the jig head provides additional action to the tail portion of the plastic lure body. The jig head may be dynamically formed to produce a variety of side to side actions when pulled forward through the water. Attractant material that fish can smell in the water may be placed in cavities in the jig head and/or lure body. As the combination has two components, the rattling or vibrations created during the combination's forward motion may develop a desirable sonic attraction.

Accordingly, it is a principal object of the invention to provide an improved fishing lure that will attract fish by its pivoting motions.

It is another object of the invention to provide an improved fishing lure that will attract fish by releasing scent into the water.

It is a further object of the invention to provide an improved fishing lure that will attract fish by sound.

Still another object of the invention is to provide an improved fishing lure that may be separated from the hook on which it is retained.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a schematic diagram of the first preferred embodiment of the invention.

FIG. 2 is a schematic diagram of the second preferred embodiment of the invention.

FIG. 3 is a schematic diagram of the third preferred embodiment of the invention.

FIG. 4 is a schematic diagram of the fourth preferred embodiment of the invention.

FIG. 5 is a schematic diagram of the fifth preferred embodiment of the invention.

FIG. 6 is a schematic diagram of the sixth preferred embodiment of the invention.

Similar reference characters denote corresponding features consistently throughout the attached drawings.

### DETAILED DESCRIPTION OF THE PREFERRED EMBODIMENTS

The present invention is a jig head and hook combination in which the jig head is pivotal about a straight portion or shank of the hook.

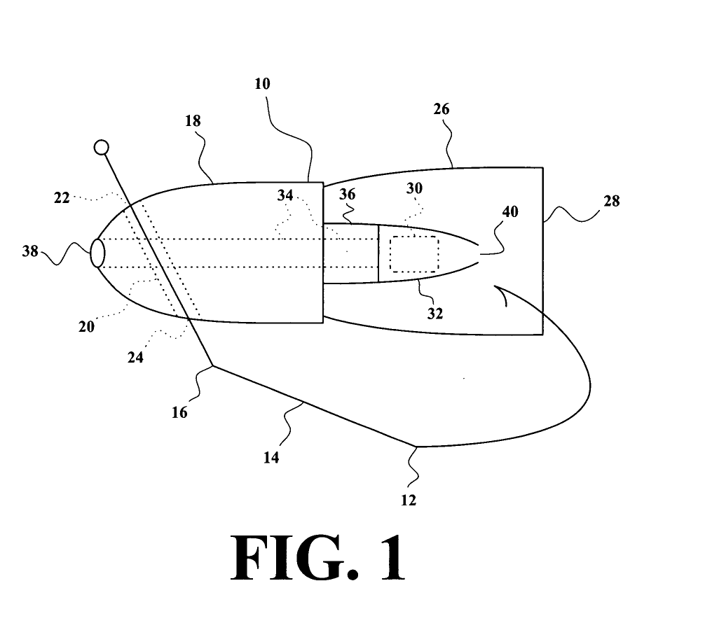

FIG. 1 shows the first preferred embodiment of the invention 10, comprising a hook 12 having a straight shank portion 14 with a bend 16, adapted to support a jig head or sinker 18. The jig head has a channel 20 which is closed except for its top opening 22 and bottom opening 24. The channel is suitably dimensioned and configured to allow the shank of the hook to be inserted there through such that the jig head is retained on and pivotal around the hook's shank. A lure body 26, preferably made of plastic, is affixed to the rear of the jig head, preferably by a fastening method such as snap-on, threading, stretch over, hooking to, or other known methods. The tail portion of the lure body 28 can be of a variety of configurations for attracting fish. A scent producing substance such as a fish attractant pellet 30 may be inserted into a cavity 32 in the lure body before it is affixed to the rear of the jig head. The is a channel for water flow 34 in the jig head and an inner front portion 36 of the lure body, with a front opening 38, so that water can flow into the cavity in the lure body. A hole for water flow 40 is provided at the rear of the cavity to enable communication of the scent of the pellet to the water behind the lure body.

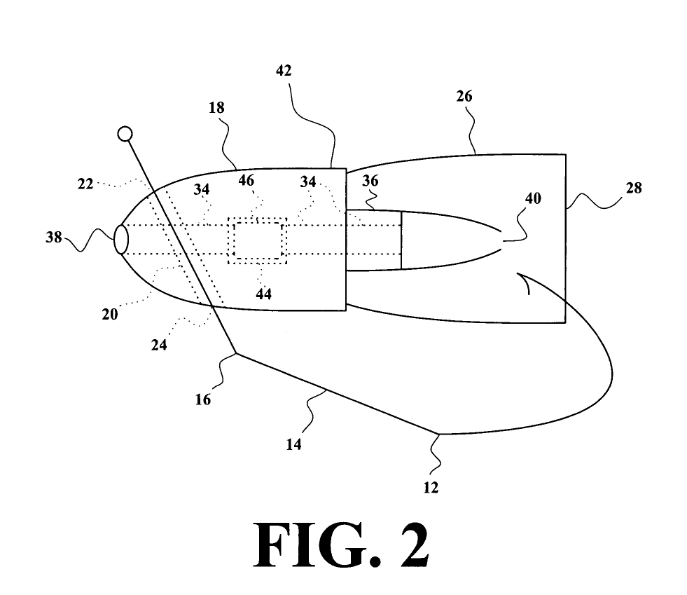

FIG. 2 shows the second preferred embodiment of the invention 42, with a cavity 44 in the jig head that can retain an attractant 46 that fish can smell.

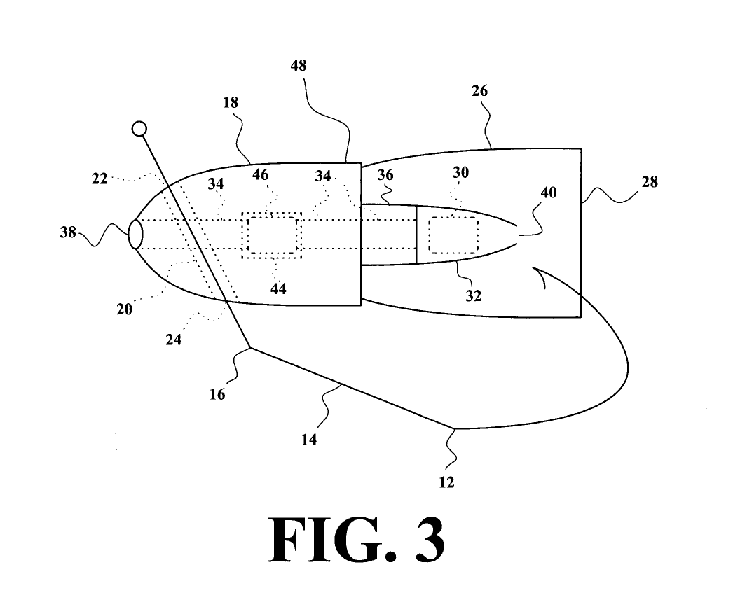

FIG. 3 shows the third preferred embodiment of the invention 48, with cavities 32 and 44 in both the jig head and lure body, each containing attractants 30 and 46 that fish can smell.

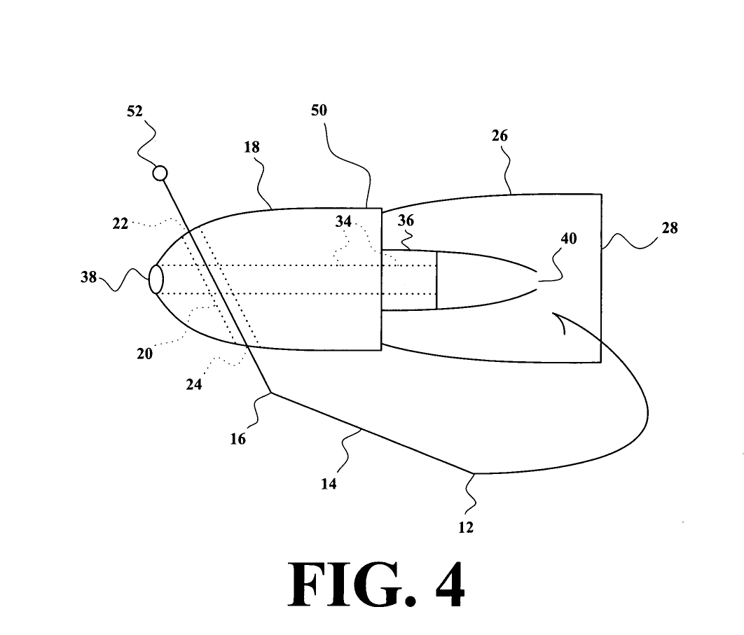

FIG. 4 shows the fourth preferred embodiment of the invention 50, with no cavities for holding attractants. Optionally, a live bait item, a foam bait item, or any other attractor may be attached externally. A knot in a fishing line (not shown in the drawings) tied to the hook eye 52 may be sufficient for retaining the jig head on the hook's shank.

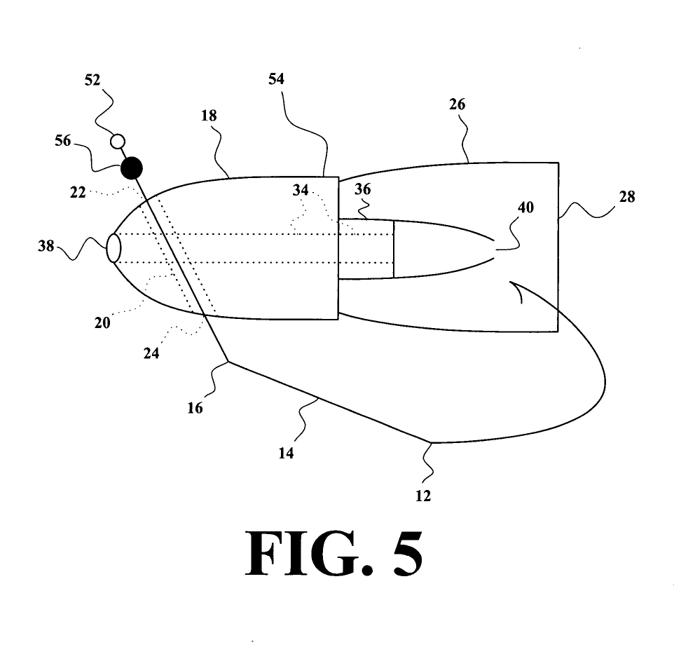

FIG. 5 shows the fifth preferred embodiment of the invention 54, which is the same as the fourth preferred embodiment, except that a bead 56 is used to keep the jig head from riding up the line.

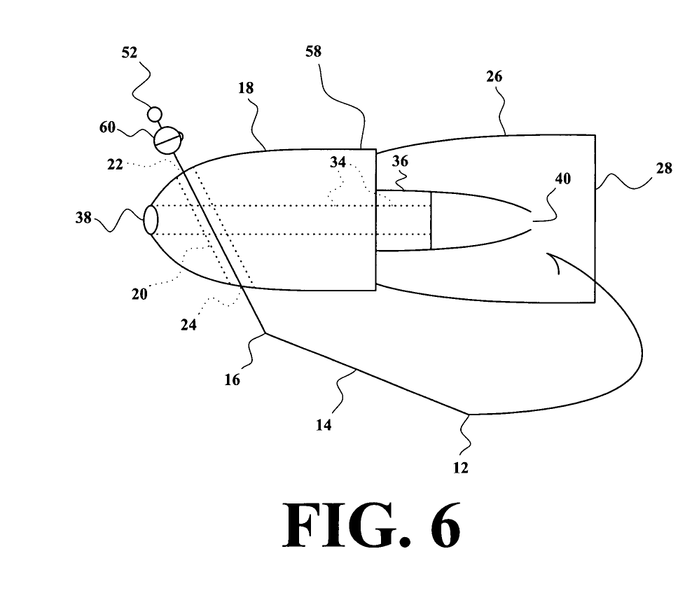

FIG. 6 shows the sixth preferred embodiment of the invention 58, which is the same as the fourth preferred embodiment, except that a split-shot 60 is used to keep the jig head from riding up the line. The split-shot is preferably two hemispheres of soft lead connected by a hinge that can be manually squeezed onto a fishing line or the shank of the hook.

It is to be understood that the present invention is not limited to the embodiments described above, but encompasses any and all embodiments within the scope of the following claims.

I claim:

1. A fishing lure, comprising:
a jig head;
a lure body retained on the jig head;
a first channel through the jig head and lure body, through which water can flow as the fishing lure is pulled through a body of water;
a cavity within the lure body, which can retain an attractant that fish can smell, situated so that water from the first channel can flow through the cavity and out at least one opening in the cavity; and
a hook having a straight first portion retained within a second channel through the jig head, said straight first portion being able to rotate within the second channel, and a curved second portion.

2. The fishing lure according to claim 1, wherein:
the jig head, the lure body and the first channel are elongated in a first direction, and the straight first portion of the hook and the second channel are elongated in a second direction that is diagonal to the first direction.

3. The fishing lure according to claim 3, wherein:
the curved second portion of hook bends back towards the lure body.

4. The fishing lure according to claim 3, wherein:
the jig head and lure body can be separated to allow an attractant to be inserted into the cavity in the lure body, then reattached to retain the attractant.

5. The fishing lure according to claim 4, wherein:
the attractant is a pellet that slowly dissolves in the water.

6. A fishing lure, comprising:
a jig head;
a lure body retained on the jig head;
a first channel through the jig head and lure body, through which water can flow as the fishing lure is pulled through a body of water;
a cavity within the jig head, which can retain an attractant that fish can smell, situated so that water from the first channel can flow through the cavity and out at least one opening in the cavity; and
a hook having a straight first portion retained within a second channel through the jig head, said straight first portion being able to rotate within the second channel, and a curved second portion.

7. The fishing lure according to claim 6, wherein:
the jig head, the lure body and the first channel are elongated in a first direction, and the straight first portion of the hook and the second channel are elongated in a second direction that is diagonal to the first direction.

8. The fishing lure according to claim 7, wherein:
the curved second portion of hook bends back towards the lure body.

9. The fishing lure according to claim 8, wherein:
the jig head and lure body can be separated to allow an attractant to be inserted into the cavity in the jig head, then reattached to retain the attractant.

10. The fishing lure according to claim 9, wherein:
the attractant is a pellet that slowly dissolves in the water.

11. The fishing lure according to claim 6, including:
a cavity within the lure body, which can retain an attractant that fish can smell, situated so that water from the first channel can flow through the cavity and out at least one opening in the cavity.

12. The fishing lure according to claim 11, wherein:
the jig head, the lure body and the first channel are elongated in a first direction, and the straight first portion of the hook and the second channel are elongated in a second direction that is diagonal to the first direction.

13. The fishing lure according to claim 12, wherein:
the curved second portion of hook bends back towards the lure body.

14. The fishing lure according to claim 13, wherein:
the jig head and lure body can be separated to allow the attractants to be inserted into the cavities in the jig head and lure body, then reattached to retain the attractants.

15. The fishing lure according to claim 14, wherein:
the attractants are pellets that slowly dissolve in the water.

16. A fishing lure, comprising:
a jig head;
a lure body retained on the jig head; and
a hook having a straight first portion retained within a channel through the jig head, said straight first portion being able to rotate within the channel, and a curved second portion;
wherein the jig head and the lure body are elongated in a first direction, and the straight first portion of the hook and the channel are elongated in a second direction that is diagonal to the first direction; and
wherein the channel has no openings except at its ends.

17. The fishing lure according to claim 16, wherein:
the curved second portion of hook bends back towards the lure body.

18. The fishing lure according to claim 17, wherein:
the straight first portion of the hook has an end extending outside the channel, and a bead is retained on said end, whereby the jig head will be prevented from riding up a fishing line on which the hook is retained.

19. The fishing lure according to claim 17, wherein:
the straight first portion of the hook has an end extending outside the channel, and a split-shot is retained on said end, whereby the jig head will be prevented from riding up a fishing line on which the hook is retained.

20. The fishing lure according to claim 17, wherein:
the straight first portion of the hook has an end extending outside the channel, and the end has an eye, whereby the jig head will be prevented from riding up a fishing line on which the hook is retained, when the fishing line is inserted through the eye and a knot is tied.
